(19) United States
(12) Patent Application Publication
(10) Pub. No.: US 2013/0017398 A1
(43) Pub. Date: Jan. 17, 2013

(54) SOIL RESIST COMPOSITIONS

(71) Applicants: JOYCE MONSON MATERNIAK, Hockessin, DE (US); Edward Patrick Carey, Atglen, PA (US)

(72) Inventors: JOYCE MONSON MATERNIAK, Hockessin, DE (US); Edward Patrick Carey, Atglen, PA (US)

(73) Assignee: E. I. DU PONT DE NEMOURS AND COMPANY, Wilmington, DE (US)

(21) Appl. No.: 13/183,984

(22) Filed: Jul. 15, 2011

(51) Int. Cl. B32B 27/08; B05D 1/18; B05D 1/02; B05D 1/28

(52) U.S. Cl. 428/421; 252/8.62; 427/429; 427/428.01; 427/430.1; 427/427.6

(57) ABSTRACT

A soil resist, oil and water repellent agent comprising a dispersion of a polyfluoro organic compound having at least one of a urea, urethane, or ester linkage, at least one anionic non-fluorinated surfactant, a nonfluorinated vinyl polymer, and amorphous silicon dioxide, particularly useful on fibers and yarns containing residual spin finish.

### BACKGROUND OF THE INVENTION

Soil resists and oil and water repellent agents are known and used on fibrous substrates such as carpets and rugs. These are applied usually after a wet dying process to color fibers for substrates such as carpets or rugs. It is standard practice to apply a spin finish to the fibers or yarn during their manufacture.

Spin finish is applied to the fibers or yarn, such as poly(trimethyleneterephthalate), also referred to as Triexta, to aid in the lubrication and friction properties, and also may act as an anti-static agent of the fibers while processing. For dyed fibers, the spin finish is usually removed during the wet dye process. For pigmented fibers, where the pigmentation occurs during fiber formation, there is limited opportunity for sufficent removal of the spin finish. This residual spin finish on the fiber is known to limit the effectiveness of common soil resists and oil and water repellents. The residual spin finish also attracts dirt to the carpet fibers.

U.S. Pat. Nos. 6,740,251 and 6,824,854 by Materniak et al., disclose soil resists having partially fluorinated urethanes and an anionic surfactant providing increased soil resistance and oil repellency to fibrous substrates, including carpets.

U.S. Pat. No. 7,754,092 by Materniak et al., discloses soil resists having partially flourinated urethanes and maleic anhydride providing soil resistance to fibrous subtrates that also allows for simultaneous applications of stain resist additives.

It is desirable to have a composition that can provide soil resistance as well as oil and water repellency to a fiber having residual spin finish present. The present invention provides such a benefit.

### SUMMARY OF THE INVENTION

The present invention is a soil resist and oil and water repellent agent comprising a dispersion of a polyfluoro organic compound having at least one of a urea, urethane, or ester linkage, at least one anionic non-fluorinated surfactant, a nonfluorinated vinyl polymer, and amorphous silicon dioxide.

The present invention further comprises a method of treating a substrate for soil resistance and oil repellency to a substrate comprising contacting said substrate with a composition of a soil resist and oil repellent comprising a dispersion of a) a polyfluoro organic compound having at least one of a urea, urethane, or ester linkage, b) at least one anionic non-fluorinated surfactant, c) a nonfluorinated vinyl polymer, and d) amorphous silicon dioxide.

The present invention further comprises a substrate treated with a soil resist and oil repellant comprising a dispersion of a) a polyfluoro organic compound having at least one of a urea, urethane, or ester linkage, b) at least one anionic non-fluorinated surfactant, c) a nonfluorinated vinyl polymer, and d) amorphous silicon dioxide.

### DETAILED DESCRIPTION

Trademarks are shown herein in upper case.

“Soil resist agent” as used herein means a composition applied to, or incorporated into, a substrate which retards and limits the build-up of dirt or soil on the substrate.

“Oil repellent agent” as used herein means a composition applied to, or incorporated into, a substrate which enables the substrate to resist wetting by oily liquids.

“Water repellent agent” as used herein means a composition applied to, or incorporated into, a substrate which enables the substrate to resist wetting by aqueous liquids.

Spin finish is any processing aid that provides lubrication and anti-static properties, as well as other known properties, to fibers to which it is applied. Residual spin finish is defined as any remaining spin finish on a fiber after normal processing.

One embodiment of the present invention is a soil resist and oil and water repellent agent comprising a dispersion of a polyfluoro organic compound having at least one of a urea, urethane, or ester linkage, at least one anionic non-fluorinated surfactant, a nonfluorinated vinyl polymer, and amorphous silicon dioxide. The soil resist and oil and water repellent agent, referred herein as “agent” is capable of providing improved soil resistance and oil and water repellency to fibers containing residual spin finish.

The present invention comprises a polyfluoro organic compound, the polyfluoro organic compound having at least one of a urea, urethane, or ester linkage.

In one embodiment, the polyfluoro organic compound is the product of the reaction of at least one organic polyisocyanate containing at least three isocyanate groups, at least one fluorochemical compound which contains per molecule a) a single functional group having one or more Zerewitinoff hydrogen atoms and b) at least two carbon atoms each of which contains at least two fluorine atoms, and water in an amount sufficient to react with from abut 5% to about 60% of the isocyanate groups in said polyisocyanate. In another embodiment, the amount of water used is sufficient to react with about 10% to about 35% of the isocyanate groups.

The fluorochemical compound has at least two carbon atoms each bonded by two fluorine atoms. One example of such fluorochemical is represented by the formula;

R_{f}—Rₖ—X—H

wherein

R_{f} is a C₂ to C₂₀ perfluoralkyl, preferably C₂ to C₆ perfluoralkyl, optionally interrupted oxygen atoms or methylene groups;

R is a divalent radical;

k is 0 or 1;

X is O, S, or N(R¹);

R¹ is H, C₁ to C₆ alkyl or R_{f}—Rₖ—.

Alternatively, the fluorochemical can be represented by the formula:

R_{f}—Rₖ—R²—X—H

wherein

R_{f} and k are as defined above;

R is the divalent radical: CₘH₂ₘSO, CₘH₂ₘSO₂, SO₂N(R³), or CON(R³);

R² is —CₙH₂ₙ—, which can be optionally end-capped by

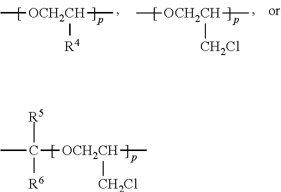

on the terminal carbon;

R³ is H or alkyl of 1 to 6 carbon atoms;

R⁴, R⁵ and R⁶ are each indepenently H or alkyl containing 1 to 6 carbon atoms; and

m is 1 to 22;

n is 0 to 12;

p is 1 to 50;

X is O, S, or N(R⁷);

R⁷ is H, alkyl containing 1 to 6 carbon atoms or a R^{f}—Rₖ—R²— group.

The divalent radical R can be represented, for example, by (CH₂)_{q} where q is 1, 2, or 3.

R_{f} can be a mixture of perfluoroalkyl groups represented by the formula CF₃CF₂(CF₂)ᵣ where r is 0 to 18. R_{f} can be a mixture of perfluoroalkyl groups where r is 2 to 4. R_{f} can be a perfluoroalkyl where r is 4. R_{f} can be branched or linear.

The fluorochemical can also be presented by either formula

H(CF₂CF₂)_{w}CH₂OH or (CF₃)₂CHOH

wherein w is 1 to from about 10.

Alternatively, the polyfluoro organic compound is the product of the reaction of at least one organic polyisocyanate containing at least three isocyanate groups, at least one nonfluorinated organic compound containing a single functional group, at least one fluorochemical compound which contains per molecule a) a single functional group having one or more Zerewitinoff hydrogen atoms and b) at least two carbon atoms each of which contains at least two fluorine atoms, and water in an amount sufficient to react with from abut 5% to about 60% of the isocyanate groups in said polyisocyanate. A non-fluorinated organic compound containing a single functional group can also be used in conjunction with one or more fluorochemicals described above to produce one or more fluorochemicals of this invention. Usually between about 1% to about 60% of the isocyanate groups of the polyisocyanate are reacted with at least one such non-fluorinated compound. An example of a non-fluorinated compound containing a single functional group used in conjunction with one or more fluorochemical compounds is

R¹⁰—R¹¹ₖ—Y—H

wherein

R¹⁰ is a C₁-C₁₈ alkyl, a C₁-C₁₈ omega-alkenyl radical or a C₁-C₁₈ omega-alkenyl;

R¹¹ is

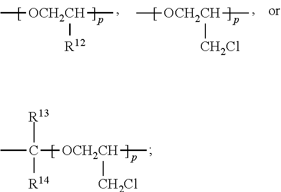

R¹², R¹³ and R¹⁴ are each independently H or alkyl radical containing 1 to 6 carbon atoms and p is 1 to 50;

Y is —O—, —S—, or —N(R¹⁶);

R¹⁶ is H or alkyl containing 1 to 6 carbon atoms; and

k and p are as defined above.

Examples of non-fluorinated compound are, but not limited to, alkanol or a monoalkyl or monoalkenyl ether or ester of a polyoxyalkylene glycol. Particular examples of such compounds include stearyl alcohol, the monomethyl ether of polyoxethylene glycol, the mono-allyl or -methallyl ether of polyoxethylene glycol, the mono-methacrylic or acrylic acid ester of polyoxethylene glycol, and the like.

Any polyisocyanate having three or more isocyanate groups can be used for the purposes of this invention. For example, one can use hexamethylene diisocyanate homopolymers having the formula:

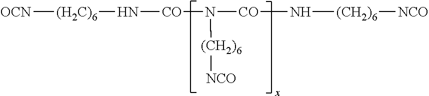

wherein x is an integer equal to or greater than 1, preferably between 1 and 8. Because of their commercial availability, mixtures of such hexamethylene diisocyanate homopolymers are preferred for purposes of this invention. Also of interest are hydrocarbon diisocyanate-derived isocyanurate trimers, which can be represented by the formula:

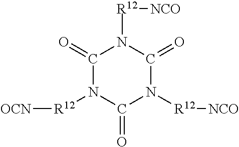

wherein R¹² is a divalent hydrocarbon group, preferably aliphatic, alicyclic, aromatic or arylaliphatic. For example, R¹² can be hexamethylene, toluene or cyclohexylene, preferably the former. Other polyisocyanates useful for the purposes of this invention are those obtained by reacting three moles of toluene diisocyanate with 1,1,1-tris-(hydroxymethyl)-ethane or 1,1,1-tris-(hydroxymethyl)-propane. The isocyanurate trimer of toluene diisocyanate and that of 3-isocyanatomethyl-3,4,4-trimethylcyclohexyl isocyanate are other examples of polyisocyanates useful for the purposes of this invention, as is methine-tris-(phenylisocyanate). Also useful for the purposes of this invention is the polyisocyanate having the formula:

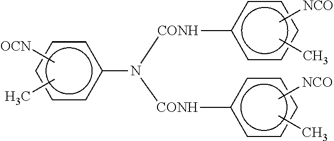

The polyfluoro organic compounds used in the invention are prepared by reacting: (1) at least one polyisocyanate or mixture of polyisocyanates which contains at least three isocyanate groups per molecule with (2) at least one fluorochemical compound which contains per molecule (a) a single functional group having one or more Zerewitinoff hydrogen atoms and (b) at least two carbon atoms each of which contains at least two fluorine atoms. Thereafter the remaining isocyanate groups are reacted with water to form one or more urea linkages. Usually between about 40% and about 95% of the isocyanate groups will have been reacted before water is reacted with the polyisocyanate. In other words, the amount of water generally is sufficient to react with from about 5% to about 60 of the isocyanate groups in the polyisocyanate. Preferably, between about 60% and 90% of the isocyanate groups have been reacted before water is reacted with the polyisocyanate, and most preferably between about 70% and 85% of the isocyanate groups have been reacted prior to reaction of water with the polyisocyanate. Thus, in a preferred embodiment the amount of water is sufficient to react with about 10% to about 35% of the isocyanate groups, most preferably between 15% and 30%.

In one embodiment, water-modified fluorochemical carbamates have been prepared by the sequential catalyzed reaction of Desmodur N-100, Desmodur N-3200 or Desmodur N-3300, or mixtures thereof, with a stoichiometric deficiency of a perfluoroalkyl compound containing one functional group, and then with water. Desmodur N-100 and Desmodur N-3200 are hexamethylene diisocyanate homopolymers commercially available from Mobay Corporation. Both presumably are prepared by the process described in U.S. Pat. No. 3,124,605 and presumably to give mixtures of the mono-, bis-, tris-, tetra- and higher order derivatives which can be represented by the general formula:

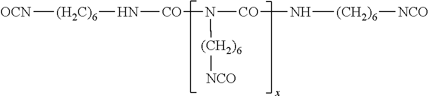

wherein x is an integer equal to or greater than 1, preferably between 1 and 8.

Based on its average equivalent weight and NCO content, the comparative bis-, tris-, tetra-, and the like, content of Desmodur N-3200 should be less than that of the N-100 product. Desmodur N-3300 is a hexamethylene diisocyanate-derived isocyanurate trimer that can be represented by the formula:

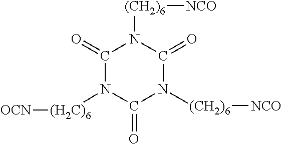

The water-modified fluorochemical carbamates are typically prepared by first charging the polyisocyanate, the perfluoroalkyl compound and a dry organic solvent such as methyl isobutyl ketone (MIBK) to a reaction vessel. The order of reagent addition is not critical. The specific weight of aliphatic polyisocyanate and perfluoroalkyl compounds charged is based on their equivalent weights and on the working capacity of the reaction vessel and is adjusted so that all Zerewitinoff active hydrogens charged will react with some desired value between 40% and 95% of the total NCO group charge. The weight of dry solvent is typically 15%-30% of the total charge weight. The charge is agitated under nitrogen and heated to 40°-70° C. A catalyst, typically dibutyltindilaurate per se, or as a solution in MIBK, is added in an amount which depends on the charge, but is usually small, e.g., 1 to 2 parts per 10,000 parts of the polyisocyanate.

After the resultant exotherm, the mixture is agitated at a temperature between 65° and 105° C. for 2-20 hours from the time of the catalyst addition, and then, after its temperature is adjusted to between 55° and 90° C., is treated with water per se or with wet MIBK for an additional 1 to 20 hours.

The use of a stoichiometric excess of a polyisocyanate assures complete reaction of the fluorinated and non-fluorinated organic compounds that, coupled with subsequent reaction with water, provides fluorochemical compounds that are preferred for use in the soil resist agents of the present invention.

In another embodiment the fluorochemical compounds suitable for use in the present invention include perfluoroalkyl esters and mixtures thereof with vinyl polymers described by Dettre et al. in U.S. Pat. No. 3,923,715, incorporated herein by reference. The fluorochemical compounds disclosed by Dettre comprise an aqueous dispersion of a composition of more than 0 and up to 95% of a non-fluorinated vinyl polymer having an adjusted Vickers Hardness of about 10 to about 20, and 5 to less than 100% of a perfluoroalkyl ester of a carboxylic acid of from 3 to 30 carbon atoms. U.S. Pat. No. 3,923,715 disclosed that volatility is important in minimizing flammability.

Many of the known esters of fluorinated alcohols and organic acids are useful as the perfluoroalkyl ester compound in the invention. Representative of the fluorinated alcohols that can be used to make the ester are (CF₃)₂CFO(CF₂CF₂)ₚCH₂CH₂OH where p is 1 to 5; (CF₃)₂CF(CF₂CF₂)_{q}CH₂CH₂OH where q is 1 to 5; R_{f}SO₂N(R′)CH₂OH where R_{f} is perfluoroalkyl of 4 to 12 carbons and R′ is H or lower alkyl; CₙF(₂ₙ₊₁)(CH₂)ₘ—OH or —SH where n is 3 to 14 and m is 1 to 12; R_{f}CH₂C(X)H(CH₂)ᵣOH where r is >1 X is —O₂C-alkyl, —(CH₂)ₛOH, —(CH₂)ₛO₂C alkyl or —OH wherein s is an integer of 0 to 10 and R_{f} is perfluoroalkyl of 3 to 21 carbons; R_{f}CON(R)—(CH₂)ₜOH where R_{f} is perfluoroalkyl of 4 to 18 carbons, t is 2 to 6 and R is an alkyl group of 4 to 10 carbons.

The preferred fluorinated esters utilize perfluoroalkyl aliphatic alcohols of the formula CₙF₍₂ₙ₊₁₎(CH₂)ₘOH where n is from about 3 to 14 and m is 1 to 3. Most preferred are esters formed from a mixture of the alcohols where n is predominantly 10, 8 and 6 and m is 2. These esters are formed by reacting the alcohol or mixture of alcohols with mono- or polycarboxylic acids which can contain other substituents and which contain from 3 to 30 carbons. In one method of preparing the esters, the alcohol is heated with the acid in the presence of catalytic amounts of p-toluenesulfonic acid and sulfuric acid, and with benzene, the water of reaction being removed as a codistillate with the benzene. The residual benzene is removed by distillation to isolate the ester.

The 2-perfluoroalkyl ethanols of the formula CₙF₍₂ₙ₊₁₎CH₂CH₂OH wherein n is from 6 to 14, and preferably a mixture of 2-perfluoroalkylethanols whose values of n are as described above, are prepared by the known hydrolysis with oleum of 2-perfluoroalkylethyl iodides, CₙF₍₂ₙ₊₁₎CH₂CH₂I. The 2-perfluoroalkylethyl iodides are prepared by the known reaction of perfluoroalkyl iodide with ethylene. The perfluoroalkyl iodides are prepared by the known telomerization reaction using tetrafluoroethylene and thus each perfluoroalkyl iodide differs by —(CF₂—CF₂)— unit.

To produce the perfluoroalkyl ester compounds useful as the fluorochemical component in the present invention wherein the number of carbon atoms in the perfluoroalkyl portion of the molecule is in the range of 6 to 14, removal of perfluoroalkyl iodides boiling below about 116°-119° C. (atmospheric boiling point of C₆F₁₃I) and above about 93°-97° C. at 5 mm pressure (666 Pa), (5 mm pressure boiling range of C₁₄F₂₉I) is carried out. This yields a mixture of perfluoroalkyl iodides wherein the number of carbon atoms in the perfluoroalkyl portion of the molecule is in the range of 6 to 14 carbon atoms. Another method for preparing esters employed as the fluorochemical component in the instant invention is to react perfluoroalkylethyl bromides or iodides with an alkali metal carboxylate in an anhydrous alcohol.

The polyfluoro organic compound is present in the composition at from about 0.5 to about 15.0% by weight. In another embodiment, the polyfluoro organic compound is present at from about 0.75 to about 12.0% by weight. In another embodiment, the polyfluoro organic compound is present at from about 1.0 to about 10% by weight.

The present invention comprises at least one anionic non-fluorinated surfactant. Any anionic non-fluorinated surfactant or blend of surfactants is useful in the practice of the present invention provided that it is in compatibility with the polyfluoro organic compound and with any dispersants used. These include anionic non-fluorinated surfactants and anionic hydrotrope non-fluorinated surfactants, including sulfonates, disulfonates, sulfates, phosphates, ethoxylates, and carboxylates. Commercially available anionic non-fluorinated surfactants suitable for use in the present invention include a salt of alpha olefin sulfonate, salt of alpha sulfonated carboxylic acid, salt of alpha sulfonated carboxylic ester, salt of 1-octane sulfonate, alkyl aryl sulfate, salt of dodecyl diphenyloxide disulfonate, salt of decyl diphenyloxide disulfonate, salt of butyl naphthalene sulfonate, salt of C₁₆-C₁₈ phosphate, salt of condensed naphthalene formaldehyde sulfonate, salt of dodecyl benzene sulfonate, salt of alkyl sulfate, salt of dimethyl-5-sulfoisophthalate, sodium salt of sulphonated ethoxylated fatty alcohol, and a blend of salt of decyl diphenyloxide disulfonate with salt of condensed naphthalene formaldehyde sulfonate. The sodium and potassium salts are preferred.

Preferred anionic non-fluorinated surfactants are the sodium or potassium salts of dodecyl diphenyloxide disulfonate, a salt of alpha olefin sulfonate, alkyl aryl sulfates, salt of alkyl sulfate, C₁₆-C₁₈ potassium phosphate, decyl diphenyloxide disulfonate, salt of dodecyl benzene sulfonate, and a blend of decyl diphenyloxide disulfonate with condensed naphthalene formaldehyde sulfonate.

The non-fluorinated anionic surfactant is present in the composition at from about 0.003 to about 10.0% by weight. In another embodiment, the non-fluorinated anionic surfactant is present at from about 0.005 to about 7.0% by weight. In another embodiment, the non-fluorinated surfactant is present at from about 0.01 to about 4% by weight.

The present invention comprises non-fluorinated vinyl polymers. By non-fluorinated vinyl polymers is meant one or more non-fluorine containing polymers derived by polymerization or copolymerization of vinyl monomers (vinyl compounds) including vinyl chloride and acetate, vinylidene chloride, methyl acrylate and methacrylate, acrylonitrile, styrene, poly(methylmethacrylate) and vinyl esters and numerous others characterized by the presence of a carbon double bond in the monomer molecule which opens during polymerization to make possible the carbon chain of the polymer. The non-fluorinated vinyl polymer has an adjusted Vickers Hardness of about 10 to about 20. The preferred non-fluorinated vinyl polymer is poly(methylmethacrylate) having an adjusted Vickers Hardness of 16.1.

The adjusted Vickers Hardness relates to the effectiveness of soil resistance. The Vickers Hardness method is described in the American Society of Testing Materials Standard E 92-67. A Vickers diamond indenter is used in an Eberbach Micro Hardness Tester (Eberbach Corp., Ann Arbor, Mich.). The procedure follows that described in American Society of Testing Materials Standard D 1474-68 for Knoop Hardness, with the following adjustments. A Vickers indenter is used instead of a Knoop indenter, a 50 g load is used instead of a 25 g load, the load is applied for 30 s instead of for 18 s, the measurement is made at 25±10% relative humidity instead of 50±5% relative humidity, and the hardness value is calculated using the Vickers formula instead of the Knoop formula.

The term “adjusted Vickers Hardness” refers to the hardness value obtained by using the Vickers formula but not the Vickers method. The vinyl polymers which function satisfactorily as a component of the soil resist agent of the invention must possess an adjusted Vickers Hardness of about 10 to 20. Adjusted hardness can be determined on a polymer sample deposited on a glass plate in solvent solution, the solvent being evaporated and a smooth coating obtained by heating at about 150° to 175° C. for 3 to 5 minutes. Alternatively, a smooth coating can be obtained by pressing between glass plates at 100° to 150° C. after the solvent has evaporated. Any suitable solvent can be employed to dissolve the polymers, ethers, ketones and other good solvent types being particularly useful. The coating should be sufficiently thick (75 to 250 micrometers) so that the indenter used in the test does not penetrate more than 15% of the coating thickness.

Poly(methylmethacrylate) lattices can be prepared by known aqueous emulsion polymerization to provide dispersions containing very fine particles of high molecular weight and narrow molecular weight distribution using an oxygen-free system and an initiator such as potassium persulfate/sodium bisulfate in combination.

The aqueous dispersion of fluorinated urethane can be blended with an aqueous latex of poly(methylmethacrylate) to make a composition which is extendible in water, and can be diluted therewith for application to substrates. The dispersion before dilution will normally contain from about 5% to 15% of the fluorinated urethane and 3 to 30% of the methyl methacrylate polymer. The fluorochemical component of the present invention can be stored and/or used as prepared or after further solvent dilution, or converted by standard technology to an aqueous dispersion using a dispersant to stabilize the dispersion. The fluorochemical component of the present invention is converted by standard technology to a dispersion in water or in a mixture of water and solvent. While it is usually desirable to minimize organic solvents in soil resist agents, residual or added solvents such as low molecular weight alcohols (e.g., ethanol) or ketones (e.g., acetone or MIBK) can be used. Preferred for use in the practice of the present invention is an aqueous dispersion optionally containing solvents and dispersion stabilizers such as glycols. This fluorochemical dispersion is combined with the anionic non-fluorinated surfactant to yield the soil resist agent of the present invention. The additional anionic non-fluorinated surfactant in the desired amount is added to the fluorochemical dispersion with stirring. This addition can be made to the fluorochemical dispersion in the concentrated form as shipped or at the point of application when diluted for use.

The non-fluorinated vinyl is present in the composition at from about 0.1 to about 30.0% by weight. In another embodiment, the non-fluorinated vinyl is present at from about 0.1 to about 20.0% by weight. In another embodiment, the non-fluorinated vinyl is present at from about 0.1 to about 15% by weight.

The present invention comprises amorphous silicon dioxide. Amorphous silicon dioxide is produced from the acidifying sodium silicate solutions which is washed and dehydrated. Amorphous silicon dioxide is commonly used as an anti-caking agent. It is surprisingly found that the addition of amorphous silicon dioxide to partially fluorinated urethanes, urea, and esters, surfactant, and nonfluorinated vinyl polymers, provides for increase in soil resistance, oil and water repellency to fibers and yarns containing residual spin finish. Amorphous silicon dioxide is commercially available from various suppliers such as W.R. Grace (Columbia, Md.).

Amorphous silicon dioxide is present at from about 0.01 to from about 10% weight. In another embodiment, the amorphous silicon dioxide is present at from about 0.05 to 8% weight. In another embodiment, the amorphous silicon dioxide is present at from about 0.1 to about 6% weight.

The present invention optionally comprises additives. Additives are compounds or compositions that provide surface effects such as no iron, easy to iron, shrinkage control, wrinkle free, permanent press, moisture control, softness, strength, anti-slip, anti-static, anti-snag, anti-pill, stain repellency, stain resistance, stain release, odor control, antimicrobial, sun protection, and similar effects. One or more such compounds or compositions that provide surface effects can be combined with the composition of the present invention and applied to the substrate. Other additives commonly used include foaming agents, lubricants, sequestering agents, leveling agents, pH adjusters, cross linkers, blocked isocyanates, hydrocarbon extenders, wetting agents, wax extenders, stain resist agents, and other additives known by those skilled in the art.

The present invention further comprises a method of treating fibrous substrates for soil resistance comprising application to the fibrous substrates of a soil resist agent comprising a dispersion in water or water and solvent of a) a polyfluoro organic compound having at least one of a urea, urethane, or ester linkage, and b) at least one anionic non-fluorinated surfactant.

Suitable substrates for the application of the agents of this invention are pigmented films, fibers, yarns, fabrics, carpeting, and other articles made from filaments, fibers, or yarns derived from natural, modified natural, or synthetic polymeric materials or from blends of these other fibrous materials that utilize spin finish in the processing step. Specific representative examples are cotton, wool, silk, nylon including nylon 6, nylon 6,6 and aromatic polyamides, polyesters including poly(ethyleneterephthalate), poly(trimethyleneterephthalate), poly(acrylonitrile), polyolefins, jute, sisal, and other cellulosics. The soil resist agents of this invention impart soil resistance and/or oil-, water-, and soil-repellency properties to fibrous substrates. The type of substrate of particular interest in accordance with the present invention is carpeting and rugs, particularly pigmented nylon, polyester, poly(trimethyleneterephthalate), or polypropylene carpeting, to which soil resist agents of the present invention are applied.

Spin finishes commonly used include numerous chemicals including large amounts of lubricants, anti-static agents, and emulsifiers. Examples of commercially available spin finishes, for example, are sold under the tradenames of SPINRITE PN (USA Fibre Solutions, Greenville, S.C.), DYSTAR FILIPAN (Dystar Textilfarben GmbH & Co., Geretsried, Germany), and LUROL (Goulston Technologies Inc., Monroe, N.C.). Spin finishes are usually applied, for example, at 0.2 to 5% weight on fiber after extruding into filaments.

The soil resist agents of the present invention are applied to suitable substrates by a variety of customary procedures. For the fibrous substrate end-use, one can apply them from an aqueous dispersion or an organic solvent solution by brushing, dipping, spraying, padding, roll coating, foaming, exhaust application, or the like. The soil resist agents of this invention are applied to the substrate as such or in combination with other textile finishes, processing aids, foaming agents, lubricants, anti-stains, and the like. This new agent provides improved soiling performance for fibers containing residual spin finish versus current carpet fluorochemical soil resist agents. The product is applied at a carpet mill, by a carpet retailer or installer prior to installation, or on a newly installed carpet.

The present invention further comprises a substrate treated with a soil resist and oil repellant comprising a dispersion of a) a polyfluoro organic compound having at least one of a urea, urethane, or ester linkage, b) at least one anionic non-fluorinated surfactant, c) a nonfluorinated vinyl polymer, and d) amorphous silicon dioxide.

The fibrous substrates of the present invention include those substrates previously described. Of particular interest is carpet, especially pigmented nylon, polyester, poly(trimethyleneterephthalate), or polypropylene carpet. The soil resist agent used to treat the substrate of the present invention is as previously described herein. A variety of methods for application of the soil resist agent are used as described above. The treated substrate of the present invention has superior resistance to soiling and/or oil-, water-, and soil repellency properties.

The present invention overcomes the inability of commercially available soil resists and oil and water repellent agent to provide soil resistance and oil and water repellency to a fiber containing residual spin finish.

### Test Methods and Materials

The following application methods and test methods were used in the Examples herein.

### Application Method A

The treatment was applied as an aqueous composition by spray application to the carpet at 25% wet pick-up (wpu) and dried to a carpet face temperature of 250° F. (121° C.). The carpet was either wet or dry prior to the application treatment.

### Test Method 1—Accelerated Soiling Test

A drum mill (on rollers) was used to tumble synthetic soil onto the carpet. Synthetic soil was prepared as described in AATCC Test Method 123-2000, Section 8. Synthetic soil, 3 g, and 1 liter of clean nylon resin beads ( 3/16 inch (0.32-0.48 cm) diameter ZYTEL 101 nylon resin beads, commercially available from E. I. du Pont de Nemours and Company, Wilmington, Del., were placed into a clean, empty canister. The canister lid was closed and sealed and the canister rotated on rollers for 5 minutes. The soil-coated beads were removed from the canister.

Total carpet sample size was 8×24 inch (20.3×60.9 cm). One test item and one control item were tested simultaneously. The carpet pile of all samples was laid in the same direction. Strong adhesive tape was placed on the backside of the carpet pieces to hold them together. The carpet samples were placed in the clean, empty drum mill with the tufts facing toward the center of the drum. The carpet was held in place in the drum mill with rigid wires. Soil-coated resin beads, 250 ml, and 250 ml of 5/16 in. diameter ball bearings (0.79 cm.), prepared as described above, were placed into the drum mill. The drum mill lid was closed and sealed. The drum was run on the rollers for 2½ minutes at 105 rpm. The rollers were stopped and the direction of the drum mill reversed. The drum was run on the rollers for an additional 2½ minutes at 105 rpm. The carpet samples were removed and vacuumed uniformly with 5 passes in each direction to remove excess dirt. The Delta E color difference for the soiled carpet was measured for the test and control items versus the unsoiled carpet for each item.

Color measurement of each carpet was conducted on the carpet following the accelerated soiling test. For each test sample and control sample the color of the carpet was measured, the sample was soiled, and the color of the soiled carpet was measured. The Delta E was the difference between the color of the soiled and unsoiled samples. Color difference was measured on each item, using a Minolta Chroma Meter CR 410 (Minolta Corporation, Ramsey, N.J.). Color readings were taken at three different areas on the carpet sample, and the average Delta E was recorded. The control carpet for each test item was of the same color and construction as the test item.

Delta Delta E was calculated by subtracting the Delta E of the control carpet from the Delta E of the test item. A larger negative value for Delta Delta E indicated that the test carpet had better performance and less soiling than the control. A larger positive value for Delta Delta E indicated that the test carpet had poorer performance and soiled more than the control.

### Test Method 2—Floor Traffic Soil Test

Carpets were installed in a busy corridor of a school or office building and subjected to human foot traffic in a controlled test area. The corridor was isolated from exits and had substantial walk-off mats and carpeted areas prior to the soiling test area. The unit “foot traffic” was the passing of one individual in either direction and was recorded with automated traffic counters. A Delta Delta E measurement was made as in Test Method 1.

### Test Method 3—Oil Repellency

Oil repellency was measured according to AATCC Test Method 118. Higher values indicate increased oil repellency.

The treated samples were tested for oil repellency by a modification of AATCC standard Test Method No. 118, conducted as follows. A substrate treated with an aqueous dispersion of polymer as previously described, is conditioned for a minimum of 2 hours at 23 C and 20% relative humidity and 65 C and 10% relative humidity. A series of organic liquids, identified below in Table 1, are then applied dropwise to the samples. Beginning with the lowest numbered test liquid (Repellency Rating No. 1), one drop (approximately 5 mm in diameter or 0.05 mL volume) is placed on each of three locations at least 5 mm apart. The drops are observed for 30 seconds. If, at the end of this period, two of the three drops are still spherical in shape with no wicking around the drops, three drops of the next highest numbered liquid are placed on adjacent sites and similarly observed for 30 seconds. The procedure is continued until one of the test liquids results in two of the three drops failing to remain spherical to hemispherical, or wetting or wicking occurs.

The oil repellency rating is the highest numbered test liquid for which two of the three drops remained spherical to hemispherical, with no wicking for 30 seconds. In general, treated samples with a rating of 5 or more are considered good to excellent; samples having a rating of one or greater can be used in certain applications.

TABLE 1
Oil Repellency Test Liquids

| Oil Repellency | |
|---|---|
| Rating Number | Test Solution |
| 1 | NUJOL Purified Mineral Oil |
| 2 | 65/35 Nujol/n-hexadecane |
| | by volume at 21 C. |
| 3 | n-hexadecane |
| 4 | n-tetradecane |
| 5 | n-dodecane |
| 6 | n-decane |
| 7 | n-octane |
| 8 | n-heptane |

Note:
NUJOL is a trademark of Plough, Inc., for a mineral oil having a Saybolt viscosity of 360/390 at 38 C. and a specific gravity of 0.880/0.900 at 15 C.

### Test Method 4—Water Repellency

The water repellency of a treated substrate was measured according to AATCC standard Test Method No. 193 and the DuPont Technical Laboratory Method as outlined in the TEFLON Global Specifications and Quality Control Tests information packet. The test determines the resistance of a treated substrate to wetting by aqueous liquids. Drops of water-alcohol mixtures of varying surface tensions are placed on the substrate and the extent of surface wetting is determined visually. Place a test carpet sample on a flat, non-absorbent surface. Beginning with the lowest numbered test liquid, carefully place one drop in several locations on the surface of the carpet sample. If no penetration or wetting of the carpet at the liquid-carpet interface and no wicking around the drop occurs, place drops of the next higher-numbered test liquid at an adjacent site on the carpet sample. Repeat this procedure until one of the higher number test liquids shows obvious wetting or wicking of the carpet under or around the drop within 10 seconds. The water repellency rating for a carpet sample is the numerical value of the highest-numbered test liquid which will not wet the carpet within 10 seconds. Higher ratings indicate greater repellency. The composition of water repellency test liquids is shown in Table 2.

TABLE 2
Water Repellency Test Liquids

| | Composition, Vol. % |
|---|---|
| Water Repellency | (Isopropyl Alcohol:Distilled |
| Rating Number | Water) |
| 1 | 2:98 |
| 2 | 5:95 |
| 3 | 10:90 |
| 4 | 20:80 |
| 5 | 30:70 |
| 6 | 40:60 |

### EXAMPLES

In the following examples the % wpu is the percent of wet pickup, and is the amount of solution applied to the carpet; it is expressed as a percentage of dry weight of the carpet sample prior to processing.

### Example 1

This example investigated the soil resist performance and oil repellency of carpet constructed with solution-pigmented SORONA poly(trimethyleneterephthalate) fiber with yarn spin finish of DYSTAR FILIPAN TC-26 (Dystar Textilfarben GmbH & Co., Geretsried, Germany) at 1.0 weight % finish-on-yarn. A composition was prepared containing 1.13 weight % of partially fluorinated condensation polymer, 0.34 weight % alpha olefin sulfonate surfactant, 0.51 weight % polymethylmethacrylate, 0.64 weight % amorphous silicon dioxide, 0.0005 weight % ACTICIDE MBS (Thor Specialties, Inc., Trumbull, Conn.), and the remainder of water. Carpet used for this example consisted of a commercial carpet (26 oz/sq.yd., 0.88 kg./sq.m.). The test composition was applied to the carpet according to Application Method A with a spray application at 25% wet pick-up (wpu). Carpet samples were evaluated by Test Methods 1, 3, and 4. The resulting data are shown in Table 3.

TABLE 3

| | ΔΔE vs. | | |
|---|---|---|---|
| Example | Untreated | Oil Repellency | Water Repellency |
| Example 1 | −10.4 | 5 | 4 |
| Untreated | | 0 | 0 |

### Comparative Example A

This comparative example investigated the soil resist performance and repellency of carpet constructed with solution-pigmented Superba heat-set SORONA Poly(trimethyleneterephthalate) fiber with yarn spin finish of SPINRITE PN 1600 (USA Fibre Solutions, Greenville, S.C.) where the soil resist, oil and water repellant agent did not contain amorphous silicon dioxide. A composition was prepared containing 0.9 weight % of a partially fluorinated urethane and 0.05 weight % of alpha olefin sulfonate surfactant, and the remainder of water. Carpet used for this example consisted of a level loop commercial carpet (24 oz/sq. yd., 0.81 kg/sq.m.). Untreated control carpet for this example did not receive a treatment. The test composition was applied to the carpet according to Application Method A with a spray application at 25% wet pick-up (wpu). Carpet samples were evaluated by Test Methods 1, 3, and 4. The resulting data are shown in Table 4.

TABLE 4

| | ΔΔE vs. | | |
|---|---|---|---|
| Example | Untreated | Oil Repellency | Water Repellency |
| Comparative | −4.2 | 0 | 0 |
| Example A | | | |
| Untreated | | 0 | 0 |

### Example 2

This example investigated the soil resist performance and oil repellency of carpet constructed with unscoured Superba heat-set SORONA Poly(trimethyleneterephthalate) fiber with yarn spin finish of DYSTAR FILIPAN TC-26 (Dystar Textilfarben GmbH & Co., Geretsried, Germany) at 1.0 weight % finish-on-yarn. A composition was prepared containing 0.68 weight % of partially fluorinated condensation polymer, 0.20 weight % alpha olefin sulfonate surfactant, 0.30 weight % polymethylmethacrylate, 0.38 weight % amorphous silicon dioxide, and the remainder of water. Carpet used for this example consisted of a commercial carpet (26 oz/sq.yd., 0.88 kg./sq.m.). Untreated control carpet for this example did not receive a treatment. The test composition was applied to the carpet according to Application Method A with a spray application at 25% wet pick-up (wpu). Carpet samples were evaluated by Test Methods 2, 3 and 4. The resulting data are shown in Table 5.

### Example 3

This example investigated the soil resist performance and oil repellency of carpet constructed with unscoured Superba heat-set SORONA Poly(trimethyleneterephthalate) fiber with yarn spin finish of DYSTAR FILIPAN TC-26 (Dystar Textilfarben GmbH & Co., Geretsried, Germany) at 1.0 weight % finish-on-yarn. A composition was prepared containing 1.13 weight % of partially fluorinated condensation polymer, 0.34 weight % alpha olefin sulfonate surfactant, 0.51 weight % polymethylmethacrylate, 0.64 weight % amorphous silicon dioxide, and the remainder of water. Carpet used for this example consisted of a commercial carpet (26 oz/sq.yd., 0.88 kg./sq.m.). Untreated control carpet for this example did not receive a treatment. The test composition was applied to the carpet according to Application Method A with a spray application at 25% wet pick-up (wpu). Carpet samples were evaluated by Test Methods 2, 3, and 4. The resulting data are shown in Table 5.

TABLE 5

| | ΔΔE vs. | ΔΔE vs. | | |
|---|---|---|---|---|
| | Untreated | Untreated | | |
| | (68,000 foot | (68,000 foot | Oil | Water |
| Example | traffics) | traffics) | Repellency | Repellency |
| Example 2 | −1.7 | −1.7 | 5 | 4 |
| Example 3 | −2.4 | −2.8 | 5 | 4 |
| Untreated | | | 0 | 0 |

### Example 4

This example investigated the soil resist performance and oil repellency of carpet constructed with unscoured Suessen heat-set SORONA Poly(trimethyleneterephthalate) fiber with yarn spin finish of SPINRITE PN 1600 at 0.5 weight % finish-on-yarn. A composition was prepared containing 0.68 weight % of partially fluorinated condensation polymer, 0.20 weight % alpha olefin sulfonate surfactant, 0.30 weight % polymethylmethacrylate, 0.38 weight % amorphous silicon dioxide, and the remainder of water. Carpet used for this example consisted of a commercial carpet (26 oz/sq.yd., 0.88 kg./sq.m.). Untreated control carpet for this example did not receive a treatment. The test composition was applied to the carpet according to Application Method A with a spray application at 25% wet pick-up (wpu). Carpet samples were evaluated by Test Methods 1 and 3. The resulting data are shown in Table 6.

TABLE 6

| | ΔΔE vs. | |
|---|---|---|
| Example | Untreated | Oil Repellency |
| Example 4 | −4.9 | 3 |
| Untreated | | 0 |

### Example 5

This example investigated the soil resist performance and oil repellency of carpet constructed with unscoured Suessen heat-set SORONA Poly(trimethyleneterephthalate) fiber with yarn spin finish of SPINRITE PN 1600 at 1.0 weight % finish-on-yarn. A composition was prepared containing 0.68 weight % of partially fluorinated condensation polymer, 0.20 weight % alpha olefin sulfonate surfactant, 0.30 weight % polymethylmethacrylate, 0.38 weight % amorphous silicon dioxide, and the remainder of water. Carpet used for this example consisted of a commercial carpet (26 oz/sq.yd., 0.88 kg./sq.m.). Untreated control carpet for this example did not receive a treatment. The test composition was applied to the carpet according to Application Method A with a spray application at 25% wet pick-up (wpu). Carpet samples were evaluated by Test Methods 1 and 3. The resulting data are shown in Table 7.

TABLE 7

| | ΔΔE vs. | |
|---|---|---|
| Example | Untreated | Oil Repellency |
| Example 5 | −5.4 | 3 |
| Untreated | | 0 |

### Example 6

This example investigated the soil resist performance and oil repellency of carpet constructed with unscoured Suessen heat-set SORONA Poly(trimethyleneterephthalate) fiber with yarn spin finish of SPINRITE PN 1600 at 1.5 weight % finish-on-yarn. A composition was prepared containing 0.68 weight % of partially fluorinated condensation polymer, 0.20 weight % alpha olefin sulfonate surfactant, 0.30 weight % polymethylmethacrylate, 0.38 weight % amorphous silicon dioxide, and the remainder of water. Carpet used for this example consisted of a commercial carpet (26 oz/sq.yd., 0.88 kg./sq.m.). Untreated control carpet for this example did not receive a treatment. The test composition was applied to the carpet according to Application Method A with a spray application at 25% wet pick-up (wpu). Carpet samples were evaluated by Test Methods 1 and 3. The resulting data are shown in Table 8.

TABLE 8

| | ΔΔE vs. | |
|---|---|---|
| Example | Untreated | Oil Repellency |
| Example 6 | −5.0 | 4 |
| Untreated | | 0 |

### Example 7

This example investigated the soil resist performance and oil repellency of carpet constructed with unscoured Suessen heat-set SORONA Poly(trimethyleneterephthalate) fiber with yarn spin finish of LUROL NF 12581 at 0.5 weight % finish-on-yarn. A composition was prepared containing 0.68 weight % of partially fluorinated condensation polymer, 0.20 weight % alpha olefin sulfonate surfactant, 0.30 weight % polymethylmethacrylate, 0.38 weight % amorphous silicon dioxide, and the remainder of water. Carpet used for this example consisted of a commercial carpet (26 oz/sq.yd., 0.88 kg./sq.m.). Untreated control carpet for this example did not receive a treatment. The test composition was applied to the carpet according to Application Method A with a spray application at 25% wet pick-up (wpu). Carpet samples were evaluated by Test Methods 1 and 3. The resulting data are shown in Table 9.

TABLE 9

| | ΔΔE vs. | |
|---|---|---|
| Example | Untreated | Oil Repellency |
| Example 7 | −5.3 | 4 |
| Untreated | | 0 |

### Example 8

This example investigated the soil resist performance and oil repellency of carpet constructed with unscoured Suessen heat-set SORONA Poly(trimethyleneterephthalate) fiber with yarn spin finish of LUROL NF 12581 at 1.0 weight % finish-on-yarn. A composition was prepared containing 0.68 weight % of partially fluorinated condensation polymer, 0.20 weight % alpha olefin sulfonate surfactant, 0.30 weight % polymethylmethacrylate, 0.38 weight % amorphous silicon dioxide, and the remainder of water. Carpet used for this example consisted of a commercial carpet (26 oz/sq.yd., 0.88 kg./sq.m.). Untreated control carpet for this example did not receive a treatment. The test composition was applied to the carpet according to Application Method A with a spray application at 25% wet pick-up (wpu). Carpet samples were evaluated by Test Methods 1 and 3. The resulting data are shown in Table 10.

TABLE 10

| | ΔΔE vs. | |
|---|---|---|
| Example | Untreated | Oil Repellency |
| Example 8 | −4.1 | 3 |
| Untreated | | 0 |

### Example 9

This example investigated the soil resist performance and oil repellency of carpet constructed with unscoured Suessen heat-set SORONA Poly(trimethyleneterephthalate) fiber with yarn spin finish of LUROL NF 12581 at 1.5 weight % finish-on-yarn. A composition was prepared containing 0.68 weight % of partially fluorinated condensation polymer, 0.20 weight % alpha olefin sulfonate surfactant, 0.30 weight % polymethylmethacrylate, 0.38 weight % amorphous silicon dioxide, and the remainder of water. Carpet used for this example consisted of a commercial carpet (26 oz/sq.yd., 0.88 kg./sq.m.). Untreated control carpet for this example did not receive a treatment. The test composition was applied to the carpet according to Application Method A with a spray application at 25% wet pick-up (wpu). Carpet samples were evaluated by Test Methods 1 and 3. The resulting data are shown in Table 11.

TABLE 11

| | ΔΔE vs. | |
|---|---|---|
| Example | Untreated | Oil Repellency |
| Example 9 | −3.1 | 3 |
| Untreated | | 0 |

What is claimed is:

1. A soil resist, oil and water repellent agent comprising a dispersion of a) a polyfluoro organic compound having at least one of a urea, urethane, or ester linkage, b) at least one anionic non-fluorinated surfactant, c) a nonfluorinated vinyl polymer, and d) amorphous silicon dioxide.

2. A soil resist, oil and water repellent agent of claim 1 wherein the polyfluoro organic compound is the product of the reaction of: 1) at least one organic polyisocyanate containing at least three isocyanate groups, 2) at least one fluorochemical compound which contains per molecule a) a single functional group having one or more Zerewitinoff hydrogen atoms and b) at least two carbon atoms each of which contains at least two fluorine atoms, and 3) water in an amount sufficient to react with from about 5% to about 60% of the isocyanate groups in said polyisocyanate.

3. A soil resist, oil and water repellent agent of claim 2 wherein for the polyfluoro organic compound the amount of water is sufficient to react with about 10% to about 35% of said isocyanate groups.

4. A soil resist, oil and water repellent agent of claim 3 wherein said fluorochemical is represented by the formula R_{f}—Rₖ—X—H
wherein,
R_{f} is a monovalent aliphatic group containing at least two carbon atoms each of which contain at least two fluorine atoms;
R is a divalent organic radical;
k is 0 or 1;
X is O, S, or N(R¹); and
R¹ is H, C₁ to C₆ alkyl, or an R_{f}—Rₖ-group.

5. A soil resist, oil and water repellent agent of claim 4 wherein R_{f} is a fully fluorinated straight chain or branched aliphatic radical of 3 to 20 carbon atoms optionally interrupted by oxygen atoms or methylene groups.

6. A soil resist, oil and water repellent agent of claim 5 wherein X is oxygen, R is —(CH₂)₂—, and k is 1.

7. A soil resist, oil and water repellent agent of claim 1 wherein the polyfluoro organic compound having at least one urea, urethane or ester linkage is a perfluoroalkyl ester of carboxylic acid of from 3 to 30 carbon atoms.

8. A soil resist, oil and water repellent agent of claim 1 wherein anionic surfactant is selected from the group consisting of a sulfonate, sulfate, disulfonate, phosphate, ethoxylate, and carboxylate.

9. A soil resist, oil and water repellent agent of claim 8 wherein the anionic surfactant is selected from the group consisting of an alpha olefin sulfonate, salt of alpha sulfonated carboxylic acid, salt of alpha sulfonated carboxylic ester, salt of 1-octane sulfonate, alkyl aryl sulfate, salt of dodecyl diphenyloxide disulfonate, salt of decyl diphenyloxide disulfonate, salt of butyl naphthalene sulfonate, salt of C₁₆-C₁₈ phosphate, salt of condensed naphthalene formaldehyde sulfonate, salt of dodecyl benzene sulfonate, salt of alkyl sulfate, sodium salt of sulphonated ethoxylated fatty alcohol, salt of dimethyl-5-sulfoisophthalate, and a blend of salt of decyl diphenyloxide disulfonate with salt of condensed naphthalene formaldehyde sodium sulfonate.

10. A soil resist, oil and water repellent agent of claim 9 wherein the anionic surfactant is selected from the group consisting of alpha olefin sulfonate, sodium dodecyl diphenyloxide disulfonate, alkyl aryl sulfate, sodium alkyl sulfate, C₁₆-C₁₈ potassium phosphate, salt of dodecyl benzene sulfonate, sodium decyl diphenyloxide disulfonate, and a blend of sodium decyl diphenyloxide disulfonate with condensed naphthalene formaldehyde sodium sulfonate

11. A soil resist, oil and water repellent agent of claim 1 wherein the non-fluorinated vinyl polymer has an adjusted Vickers Hardness of about 10 to about 20

12. A soil resist, oil and water repellent agent of claim 11 wherein the non-fluorinated vinyl polymer is poly(methylmethacrylate).

13. A method of treating a substrate for soil resistance and oil repellency to a substrate comprising contacting said substrate with a composition of a soil resist and oil repellent comprising a dispersion of a) a polyfluoro organic compound having at least one of a urea, urethane, or ester linkage, b) at least one anionic non-fluorinated surfactant, c) a nonfluorinated vinyl polymer, and d) amorphous silicon dioxide.

14. A method of claim 13 wherein said contacting is by brushing, dipping, spraying, padding, roll coating, exhaust application, or foaming.

15. A substrate treated with a soil resist and oil repellant comprising a dispersion of a) a polyfluoro organic compound having at least one of a urea, urethane, or ester linkage, b) at least one anionic non-fluorinated surfactant, c) a nonfluorinated vinyl polymer, and d) amorphous silicon dioxide.

16. A substrate of claim 15, wherein the substrate is nylon, wool, polyester, poly(trimethyleneterephthalate), or polypropylene.

17. A substrate of claim 16, wherein the substrate is polyester, poly(trimethyleneterephthalate), or polypropylene.

18. A substrate of claim 18, wherein the substrate is poly(trimethyleneterephthalate).
